(19) United States
(12) Patent Application Publication
(10) Pub. No.: US 2025/0239872 A1
(43) Pub. Date: Jul. 24, 2025

(54) MULTIFUNCTIONAL BATTERY CHARGER

(71) Applicant: MIN LI, Huizhou (CN)

(72) Inventor: MIN LI, Huizhou (CN)

(21) Appl. No.: 18/429,555

(22) Filed: Feb. 1, 2024

(30) Foreign Application Priority Data
Jan. 23, 2024 (CN) 202420164322.9

(51) Int. Cl. H02J 7/00

(52) U.S. Cl. CPC H02J 7/0045; H02J 7/00047; H02J 7/0013; H02J 7/0049

(57) ABSTRACT

The present disclosure provides a multifunctional battery charger including: an installation component. An interior of the installation component is provided with an external charging component and a charging component, the charging component is provided below the external charging component, a front of a housing is provided with a charging indicator light and a magnetic charging head, the magnetic charging head is connected to a magnetic adapter, one end of the magnetic adapter is inserted into a charging port of a battery. Some battery charging ports are provided at one side, some battery charging ports are provided on a head portion. Whether on the side or the head portion, they can be charged flexibly, solve a problem that most charging plugs of existing chargers are fixed.

### CROSS-REFERENCE TO RELATED APPLICATIONS

This application claims priority to Chinese Patent Application No. 202420164322.9, filed on Jan. 23, 2024, which is hereby incorporated by reference in its entirety.

### TECHNICAL FIELD

The present disclosure relates to the field of charger technologies, and in particular, to a multifunctional battery charger.

### BACKGROUND

A rechargeable battery is a rechargeable battery with limited charging times, which can be reused when used in combination with a charger through charging; and charge the battery, and thus, a battery charger is required.

As for the current traditional battery charger, its charging mode is single, which leads to it only being able to charge a single type of battery, rendering its application flexibility low. At the same time, charging plugs of existing chargers are mostly fixed, rendering it difficult to replace and handle, and it is prone to encounter with plug mismatch during use.

### SUMMARY

Embodiments of the present disclosure relates to a multifunctional battery charger, which has an installation component and a charging component. By providing with battery jars at a bottom of a housing to fix positive electrode plates and negative electrode plates, it can charge a traditional battery under an action of a charging board. At the same time, it can be used in combination with a plug-in charging board to charge a new battery, allowing it to charge multiple batteries under a cooperation of two sets of components to increase an applicability of the charger; a front of the housing is provided with a charging indicator light and a magnetic charging head, the magnetic charging head is connected to a magnetic adapter. One end of the magnetic adapter is inserted into the charging port of the new battery. Some battery charging ports are provided on one side, while some battery charging ports are provide at a head portion. Whether on the side or the head portion, they can be charged flexibly, the charging is vertically charged when the battery charging ports provided at the head portion and the charging is horizontally charged at a groove when the battery charging ports provided at the side, which renders it convenient and flexible.

A first aspect of the present disclosure provides a multifunctional battery charger, including: an installation component comprising a housing, a clamp slot, battery jars, and a charging port; where the housing is in a shape of a cuboid, an internal of the housing is in a shape of a cavity, an outer wall of the housing is provided with a shaft hole; where an interior of the installation component is provided with an external charging component and a charging component; the charging component is provided below the external charging component; the external charging component includes a plug-in punch plate, magnetic suction holes, an indicator light, and a new battery; the plug-in punch plate is fixed in the housing by a screw; the plug-in punch plate is in a shape pf a square plate, a top of the plug-in punch plate is provided with a rectangular groove, the rectangular groove of the plug-in punch plate is connected to a circular socket, the top of the plug-in punch plate is provided with semi cylindrical grooves at an equidistant; the charging component includes a charging board, a charging interface, a magnetic suction charging block, a magnetic charging adapter, an indicator board, positive electrode plates, negative electrode plates, and a traditional battery; the charging board is fixed in the housing by a screw, a control unit on the charging board is electrically connected to the indicator light, the charging interface is inserted in the charging port, the magnetic charging block is inserted into the magnetic suction holes, the magnetic charging adapter is inserted into the magnetic suction holes, the magnetic charging adapter is inserted into the new battery, the indicator board is inserted into the clamp slot, the positive electrode plates are inserted into the battery jars, the negative electrode plates are inserted into the battery jars, and the traditional battery is inserted into the battery jars; the magnetic charging block is in a shape of cylindrical, a top of the magnetic charging block is provided with a magnetic suction head; the magnetic charging block is fixed on the charging board and is connected to a control circuit on the charging board.

At least in some embodiments, the clamp slot is in a shape of a rectangular groove, the clamp slot is provided at a bottom of the housing and the clamp slot is connected to an interior of the housing; the battery jars are provided with a semi-cylindrical groove and are connected with two sets of rectangular through holes; the battery jars are evenly distributed at the bottom of the housing.

At least in some embodiments, the installation component further includes an upper cover; the charging port is a rectangular through hole, the charging port is provided on an outer wall of the housing; the upper cover is in a shape of a square plate, an inner wall of the upper cover is provided with a cylindrical protrusion; the upper cover is rotatably connected to an outside of the housing through the cylindrical protrusion.

At least in some embodiments, the magnetic suction holes are circular through holes, and the magnetic suction holes are provided in the rectangular groove of the plug-in punch plate at equidistant.

At least in some embodiments, the indicator light is inserted into the circular socket of the plug-in punch plate; an outer wall or a bottom surface of the new battery is provided with a socket.

At least in some embodiments, the charging board is in a shape of a square plate, a charging unit is provided on the charging board, the control circuit is provided on the charging board; the charging interface is fixed on the charging board, and the charging interface is connected to the control circuit on the charging board.

At least in some embodiments, a bottom of the magnetic charging adapter is provided with a magnetic suction head, the magnetic charging adapter is magnetically connected to the top of the magnetic charging block; the indicator board is in a shape of a square plate, a display light is provided in the indicator board; the indicator board is electrically connected to the charging board.

At least in some embodiments, the positive electrode plates are fixedly at a bottom of the charging board at equidistance, the positive electrode plates are connected to the control circuit on the charging board; the negative electrode plates are fixed at the bottom of the charging board at equidistant, and the negative electrode plates are connected to the control circuit on the charging board.

At least in some embodiments, the traditional battery is inserted between the positive electrode plates and the negative electrode plates.

The multifunctional battery charger provided by the present disclosure has the following beneficial effects:

The present disclosure is provided with a housing and an upper cover, battery jars are provided at a bottom of the housing, the battery jars are evenly spaced, rendering it convenient to fix multiple sets of traditional batteries at once and charge them at the same time. Compared with a single charging method of a battery with a charging socket, the product can charge multiple batteries at once, which is convenient and flexible. By rotating the top cover of the housing, it is convenient to protect the battery in a charging state during a charging process.

In addition, a plug-in charging board and magnetic suction holes are provided to fix the charging board inside the housing. At the same time, the magnetic suction holes are used to constrain the magnetic charging block and the magnetic charging adapter so as to charge a new battery while maintaining stability. In addition, positive and negative electrode plates are used to charge the traditional battery, increasing an overall adaptability of the product.

In addition, a magnetic charging block and a magnetic charging adapter are provided. The magnetic charging block is connected to a control circuit on the charging board to charge the battery through magnetic suction. At the same time, it is also connected to the magnetic charging adapter through magnetic suction to replace the magnetic charging adapter according to the charging port on the battery, rendering it convenient to charge batteries with multiple plugs.

In addition, an indicator light and an indicator board have been provided. By fixing the indicator light and indicator board separately in the plug-in punch plate and clamp slot, it is easy to display the charging status of the corresponding battery, so that they can be removed in a timely manner after the battery is fully charged.

### BRIEF DESCRIPTION OF DRAWINGS

In order to provide a clearer explanation of the technical solution of the embodiments of the present disclosure, the drawings of the embodiments will be briefly introduced below.

The drawings in the following description only relate to some embodiments of the present disclosure, rather than limiting the present disclosure.

FIG. 1 illustrates a schematic diagram of a three-dimensional structure of a multifunctional battery charger according to an embodiment of the present disclosure.

FIG. 2 illustrates a schematic diagram of a three-dimensional top-down structure of the multifunctional battery charger according to an embodiment of the present disclosure.

FIG. 3 illustrates a schematic diagram of a decomposition structure of the multifunctional battery charger according to an embodiment of the present disclosure.

FIG. 4 illustrates a schematic diagram of a decomposed top-down structure of the multifunctional battery charger according to an embodiment of the present disclosure.

FIG. 5 illustrates a schematic diagram of a local section structure of the multifunctional battery charger according to an embodiment of the present disclosure.

FIG. 6 illustrates a schematic diagram of an assembly charging structure of a novel battery according to an embodiment of the present disclosure.

FIG. 7 illustrates a schematic diagram of a top-down structure of a charging assembly of the novel battery according to an embodiment of the present disclosure.

FIG. 8 illustrates a schematic diagram of an assembly structure of an installation component according to an embodiment of the present disclosure.

FIG. 9 illustrates a schematic diagram of an assembly structure of an external charging component according to an embodiment of the present disclosure.

FIG. 10 illustrates a schematic diagram of an assembly structure of the charging component according to an embodiment of the present disclosure.

FIG. 11 illustrates a schematic diagram of a plug-in assembly structure of the novel battery according to an embodiment of the present disclosure.

Numeral reference: 1. Installation component; 101. Housing; 102. Clamp slot; 103. Battery jar; 104. Charging port; 105. Upper cover; 2. External charging component; 201. Plug-in punch plate; 202. Magnetic suction hole; 203. Indicator light; 204. New battery; 3. Charging component; 301. Charging board; 3011. Charging interface; 302. Magnetic charging block; 303. Magnetic charging adapter; 304. indicator board; 305. Positive electrode plate; 306. Negative electrode plate; 307. Traditional battery.

### DESCRIPTION OF EMBODIMENTS

Below, a further detailed description of the embodiments of the present disclosure will be provided in combination with the drawings and embodiments.

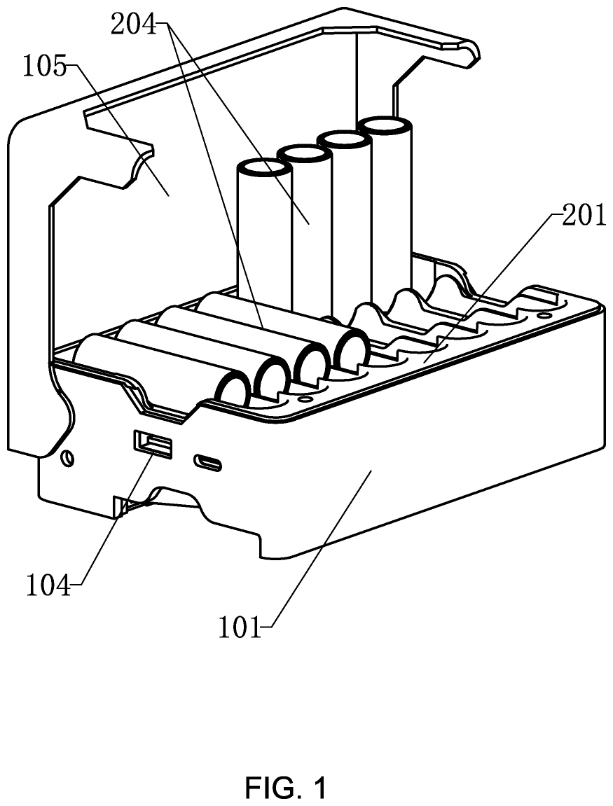

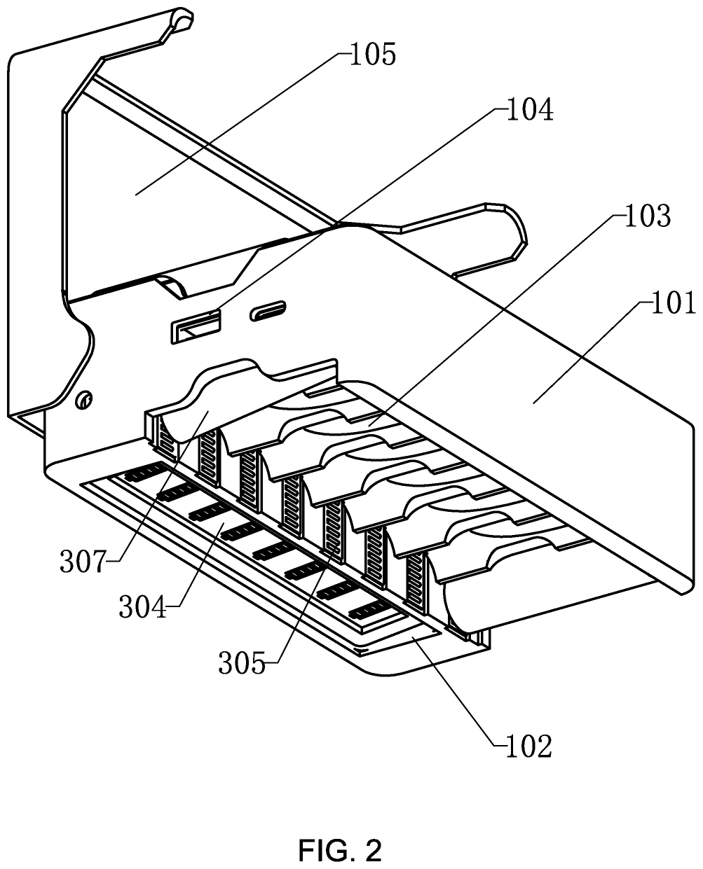

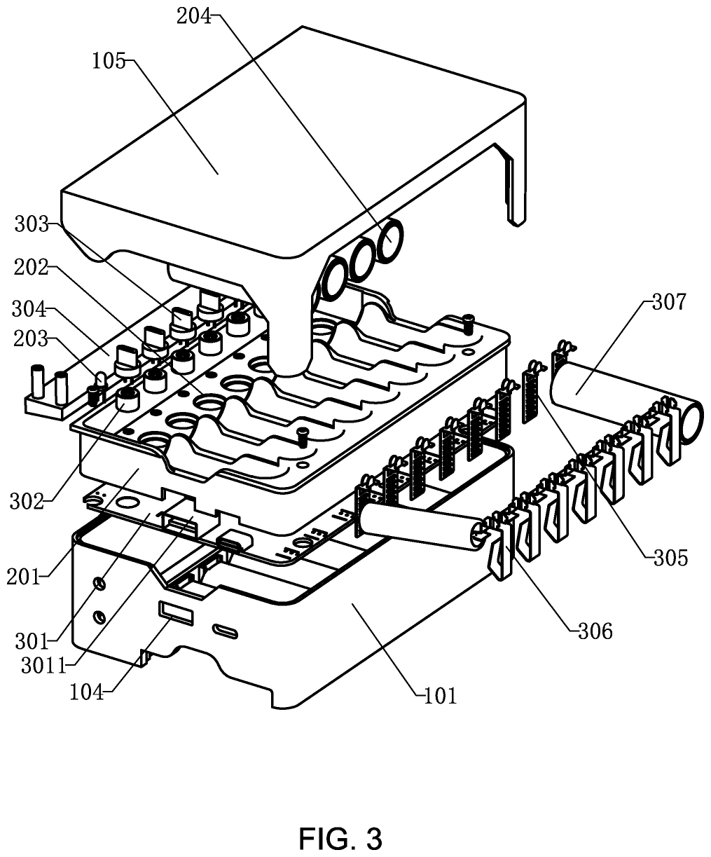

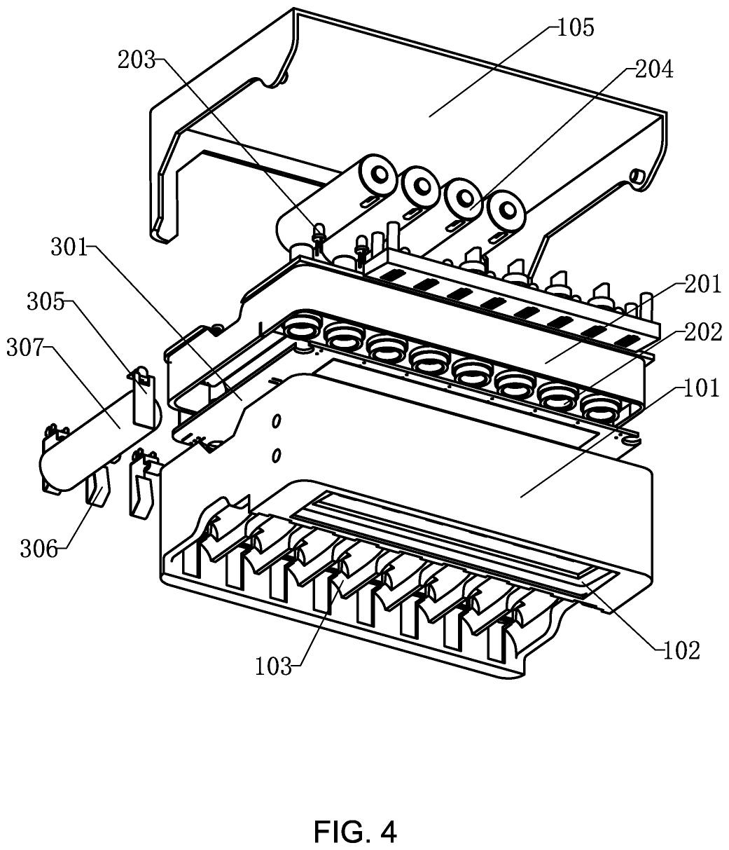

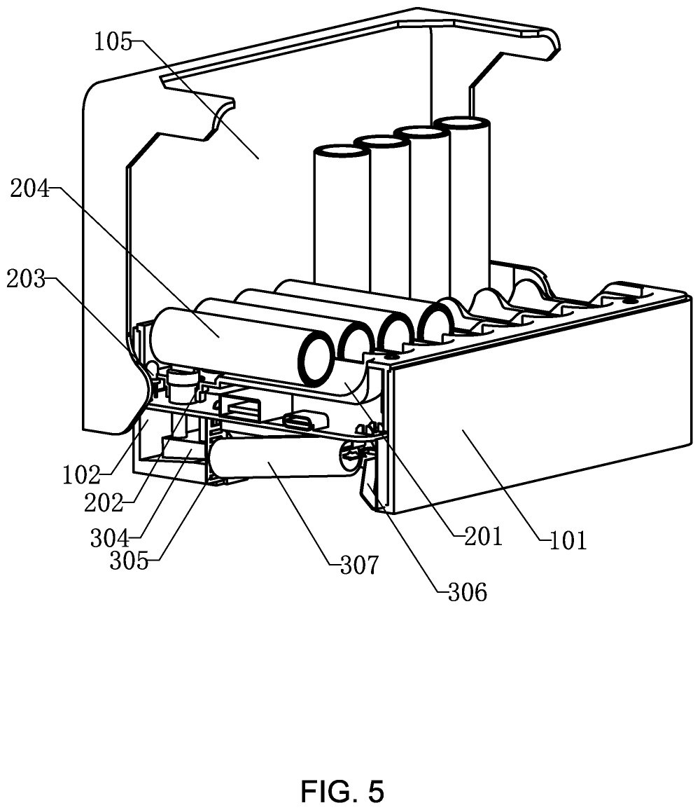

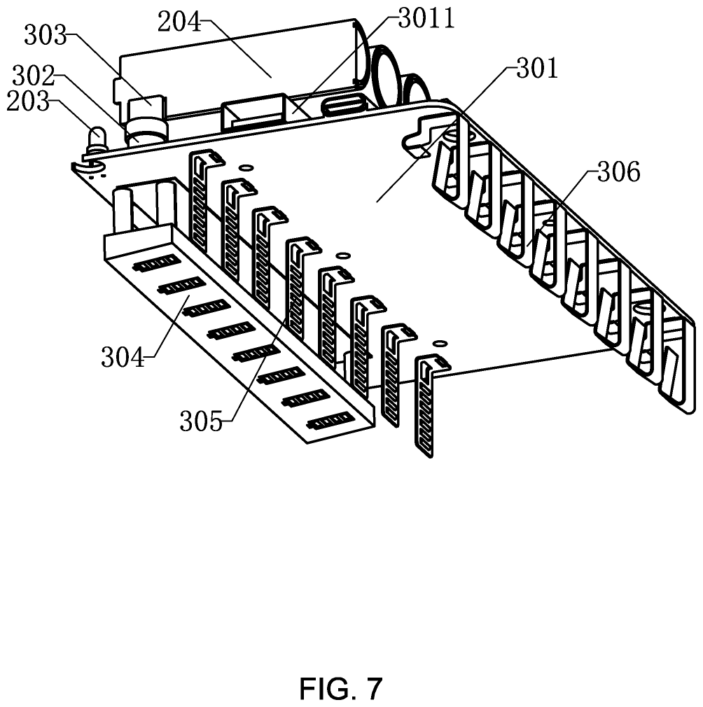

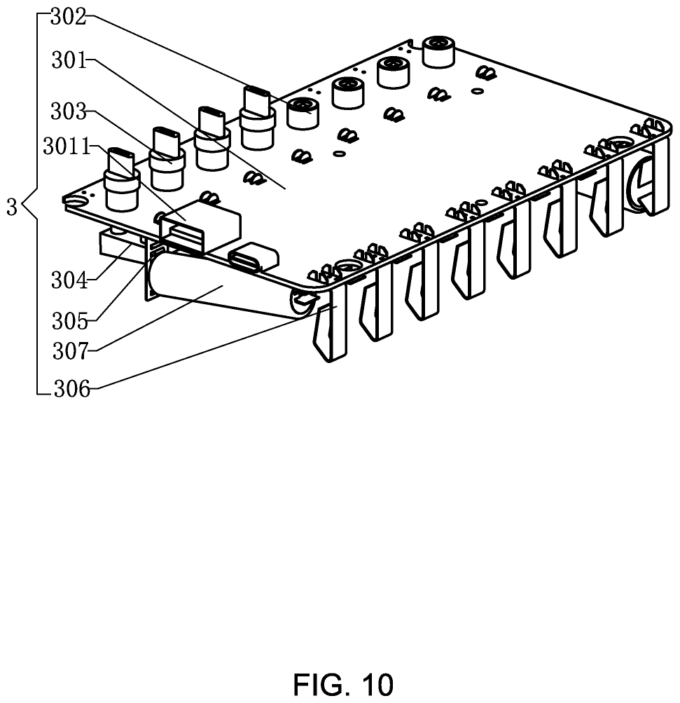

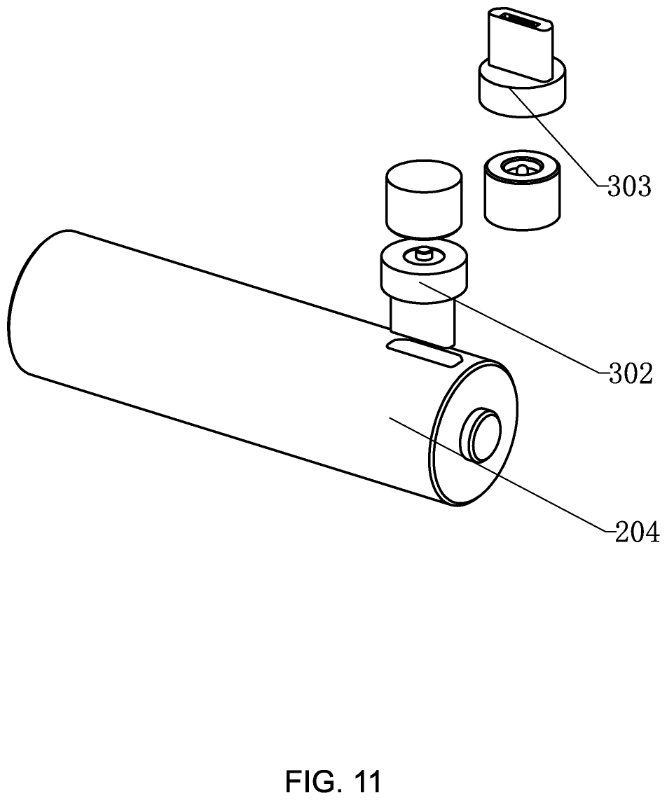

Embodiment 1: Please refer to FIGS. 1 to 11: the present disclosure provides a multifunctional battery charger, including: an installation component 1, the installation component 1 includes a housing 101, a clamp slot 102, battery jars 103, and a charging port 104. The housing 101 is in a shape of a cuboid, an interior of the housing 101 is in a shape of a cavity. An outer wall of the housing 101 is provided with a shaft hole. The housing 101 is used to assist in installing and fixing other structures of the device (the multifunctional battery charger), so that an overall stability of the device can be maintained, thereby facilitating a charging process of the battery. An interior of installation component 1 is provided with an external charging component 2 and a charging component 3. The charging component 3 is provided below the external charging component 2; the external charging component 2 includes a plug-in punch plate 201, magnetic suction holes 202, an indicator light 203, and a new battery 204. The plug-in punch plate 201 is fixed in the housing 101 by a screw. The plug-in punch plate 201 is in a shape of a square plate, a top of the plug-in punch plate 201 is provided with a rectangular groove, the rectangular groove of the plug-in punch plate 201 is connected to a circular socket, the top of the plug-in punch plate 201 is provided with a semi cylindrical groove. The plug-in punch plate 201 is used to assist in constraining the new battery 204, so that the new battery 204 can charge it while maintaining stability. The charging component 3 includes a charging board 301, a charging interface 3011, a magnetic charging block 302, a magnetic charging adapter 303, an indicator board 304, positive electrode plates 305, negative electrode plates 306, and a traditional battery 307. The charging board 301 is fixed in the housing 101 by a screw, a control unit on the charging board 301 is electrically connected to the indicator light 203, the charging interface 3011 is inserted in the charging port 104, the magnetic charging block 302 is inserted into the magnetic suction holes 202, the magnetic charging adapter 303 is inserted into the magnetic suction holes 202, the magnetic charging adapter 303 is inserted into the new battery 204, the indicator board 304 is inserted into the clamp slot 102, the positive electrode plates 305 are inserted into the battery jars 103, the negative electrode plates 306 are inserted into the battery jars 103, the traditional battery 307 is inserted into the battery jars 103. The magnetic charging block 302 is in a shape of cylindrical, a top of the magnetic charging block 302 is provided with a magnetic suction head. The magnetic charging block 302 is fixed on the charging board 301 and is connected to a control circuit on the charging board 301. The magnetic charging block 302 can magnetically charge a battery without a socket and can also be used in combination with the magnetic charging adapter 303 to charge the new battery 204 for its use.

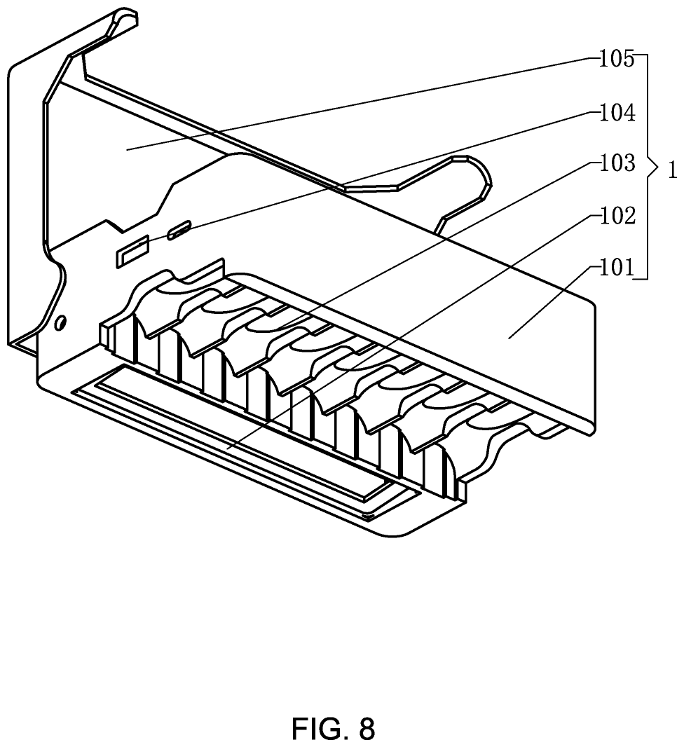

Embodiment 2: Based on Embodiment 1, as shown in FIG. 8, the clamp slot 102 is in a shape of a rectangular groove, the clamp slot 102 is provided at a bottom of the housing 101. The clamp slot 102 is connected to an interior of the housing 101. The clamp slot 102 is used to assist in fixing the indicator board 304, making it stable and convenient for a normal use. The battery jars 103 are provided with a semi-cylindrical groove and are connected to two sets of rectangular through holes. The battery jars 103 are evenly distributed at the bottom of the housing 101. The battery jars 103 are used to assist in the installation of a traditional battery 307 to coordinate with positive electrode plates 305 and negative electrode plates 306 for fixed charging treatment of traditional battery 307. The installation component 1 further includes an upper cover 105. The charging port 104 is a rectangular through hole and is provided on an outer wall of the housing 101. The charging port 104 is used to fix the charging interface 3011, so that it can be plugged into an external connection line and assist in charging processing. The upper cover 105 is in a shape of a square plate, an inner wall of the upper cover 105 is provided with a cylindrical protrusion. The upper cover 105 is rotationally connected to an outside of the housing 101 through the cylindrical protrusion. The upper cover 105 is used to cover the top of the device by flipping it over so as to protect the internal structure while maintaining stability.

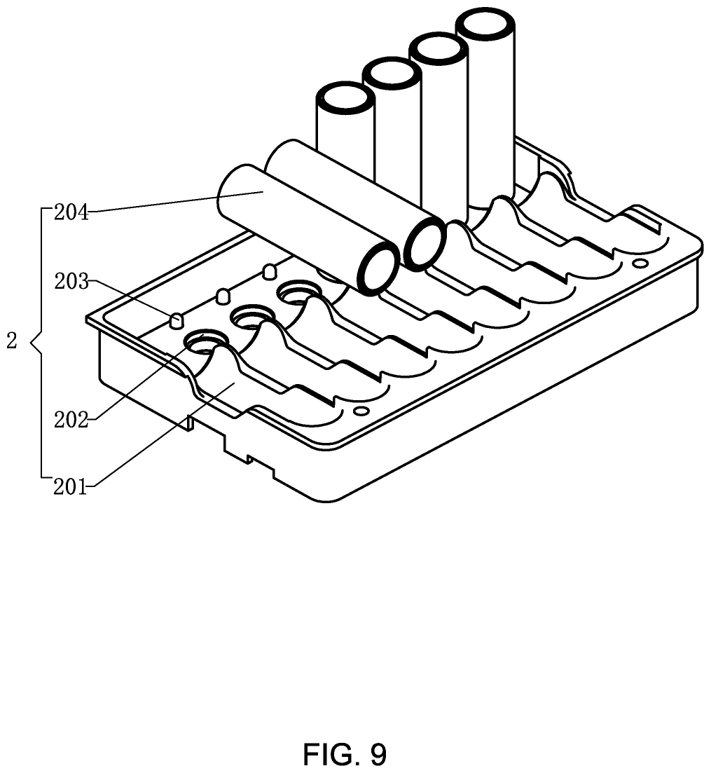

In this embodiment, as shown in FIG. 9, the magnetic suction holes 202 are circular through holes, and the magnetic suction holes 202 are provided in the rectangular groove of the plug-in punch plate 201 at equidistant. The magnetic suction holes 202 are used to assist in the installation and fixing of the magnetic charging block 302 and the magnetic charging adapter 303 so as to maintain overall stability and make it easy to use. The indicator light 203 is inserted into the circular socket of the plug-in punch plate 201. The indicator light 203 is used to display brightness when charging the new battery 204 at an opposite magnetic charging block 302 and the magnetic charging adapter 303 so as to indicate a charging status and facilitate timely removal of a fully charged new battery 204. The new battery 204 is provided with a socket on an outer wall or a bottom surface. The new battery 204 is used for charging processing through the socket on the outer wall or bottom surface.

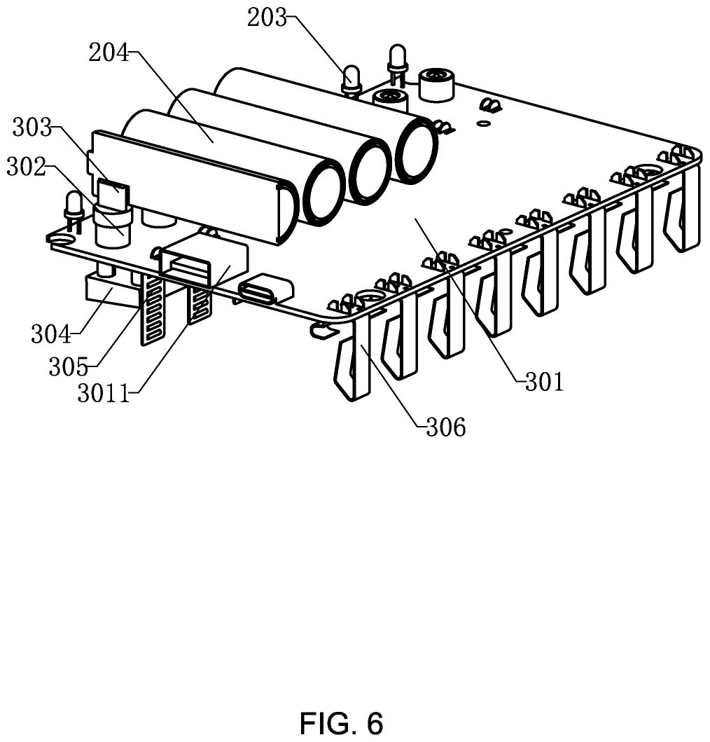

In this embodiment, as shown in FIGS. 6, 7, and 10, the charging board 301 is in a shape of a square plate, a charging unit is provided on the charging board 301, a control circuit is provided on the charging board 301. The charging board 301 is used to charge the new battery 204 and the traditional battery 307 through internal control circuit, control unit, and other structures of the charging unit control device so as to simultaneously meet the charging demands of multiple batteries. The charging interface 3011 is fixed on the charging board 301 and is connected to the control circuit on the charging board 301. The charging interface 3011 is used to connect with an external charging cable so as to charge the new battery 204 and the traditional battery 307, making it easy to use. A bottom of the magnetic charging adapter 303 is provided with a magnetic suction head, which is magnetically connected to the top of the magnetic charging block 302. The magnetic charging adapter 303 is used to connect to the magnetic charging block 302 through magnetic suction while maintaining stability so as to charge the new battery 204 in combination with the two components. The indicator board 304 is arranged in a shape of a square plate e, a display light is provided in the indicator board 304. The indicator board 304 is electrically connected to the charging board 301. The indicator board 304 is used to display the charging status of the traditional battery 307 through an internal display light so as to assist in monitoring the charging status of the traditional battery 307. The positive electrode plates 305 are fixed at a bottom of the charging board 301 at equidistant and are connected to the control circuit on the charging board 301. The positive electrode plates 305 are used with the negative electrode plates 306 to charge the traditional battery 307 for its cyclic use. The negative electrode plates 306 are fixed at the bottom of the charging board 301 at equidistant and are connected to the control circuit on the charging board 301. The negative electrode plates 306 are used in combination with the positive electrode plates 305 to charge the traditional battery 307 for its cyclic use. The traditional battery 307 is inserted between the positive electrode plates 305 and the negative electrode plates 306. The traditional battery 307 is used for charging treatment under an action of the positive electrode plates 305 and the negative electrode plates 306 for use.

A specific usage and function of this embodiment: in the present disclosure, during an installation, the charging board 301 is clamped in the housing 101, and during an insertion process, the indicator board 304 is inserted into the clamp slot 102. At the same time, the positive electrode plates 305 and the negative electrode plates 306 are inserted into the battery jars 103. Then, the plug-in punch plate 201 is fixed above the housing 101 with a screw to maintain stability while pressing the charging board 301 to maintain stability while fixing the plug-in punch plate 201, the magnetic charging block 302 is stuck in the magnetic suction holes 202, and then the upper cover 105 is rotated and connected to the housing 101.

When charging the new battery 204, and when the new battery 204 supports a magnetic suction charging function, a magnetic suction end of the new battery 204 is directly inserted into the magnetic suction holes 202 to render a direct contact with the magnetic charging block 302, so as to magnetically treat the new battery 204 through magnetic suction. When the new battery 204 does not support magnetic suction charging function, a corresponding magnetic charging adapter 303 is connected to the magnetic charging block 302 through magnetic attraction, and after the connection, the new battery 204 is connected to the magnetic charging adapter 303 to charge the new battery 204. During the charging process, the indicator light 203 of the new battery 204 lights up under the control unit on the charging board 301 to synchronize the charging status of the new battery 204.

When charging the traditional battery 307, the traditional battery 307 is directly clamped in the clamp slot 102 and fixed between the positive electrode plates 305 and negative electrode plates 306 during an insertion process, allowing it to be charged through the positive electrode plates 305 and negative electrode plates 306. During the insertion process, a corresponding display light in the indicator board 304 lights up, rendering it easier to synchronously display the charging status of the traditional battery 307.

In present disclosure, the following points need to be noted:
1. The drawings of embodiments of the present disclosure only relate to the structures related to the embodiments, and other structures can refer to a usual design.
2. Without conflict, the embodiments disclosed herein and the features in the embodiments can be combined with each other to obtain new embodiments.

The above is only the specific implementation modes disclosed in the present disclosure, but the protection scope of disclosed in the present disclosure is not limited to this. Any technical personnel familiar with the technical field within the disclosure scope of who can easily think of changes or replacements should be covered within the protection scope of disclosed in the present disclosure. Therefore, the protection scope disclosed in the present disclosure shall be based on the protection scope of the claims.

What is claimed is:

1. A multifunctional battery charger, comprising:
an installation component (1) comprising a housing (101), a clamp slot (102), battery jars (103), and a charging port (104);
wherein the housing (101) is in a shape of a cuboid, an internal of the housing (1) is in a shape of a cavity, an outer wall of the housing (1) is provided with a shaft hole;
wherein an interior of the installation component (1) is provided with an external charging component (2) and a charging component (3); the charging component (3) is provided below the external charging component (2); the external charging component (2) comprises a plug-in punch plate (201), magnetic suction holes (202), an indicator light (203), and a new battery (204); the plug-in punch plate (201) is fixed in the housing (101) by a screw; the plug-in punch plate (201) is in a shape of a square plate, a top of the plug-in punch plate (201) is provided with a rectangular groove, the rectangular groove of the plug-in punch plate (201) is connected to a circular socket, the top of the plug-in punch plate (201) is provided with semi cylindrical grooves at an equidistant;
the charging component (3) comprises a charging board (301), a charging interface (3011), a magnetic charging block (302), a magnetic charging adapter (303), an indicator board (304), positive electrode plates (305), negative electrode plates (306), and a traditional battery (307); the charging board (301) is fixed in the housing (101) by a screw, a control unit on the charging board (301) is electrically connected to the indicator light (203), the charging interface (3011) is inserted in the charging port (104), the magnetic charging block (302) is inserted into the magnetic suction holes (202), the magnetic charging adapter (303) is inserted into the magnetic suction holes (202), the magnetic charging adapter (303) is inserted into the new battery (204), the indicator board (304) is inserted into the clamp slot (102), the positive electrode plates (305) are inserted into the battery jars (103), the negative electrode plates (306) are inserted into the battery jars (103), and the traditional battery (307) is inserted into the battery jars (103); the magnetic charging block (302) is in a shape of cylindrical, a top of the magnetic charging block (302) is provided with a magnetic suction head; the magnetic charging block (302) is fixed on the charging board (301) and is connected to a control circuit on the charging board (301).

2. The multifunctional battery charger according to claim 1, wherein the clamp slot (102) is in a shape of a rectangular groove, the clamp slot (102) is provided at a bottom of the housing (101) and the clamp slot (102) is connected to an interior of the housing (101); the battery jars (103) are provided with a semi-cylindrical groove and are connected with two sets of rectangular through holes; the battery jars (103) are evenly distributed at the bottom of the housing (101).

3. The multifunctional battery charger according to claim 1, wherein the installation component (1) further comprises an upper cover (105); the charging port (104) is a rectangular through hole, the charging port (104) is provided on an outer wall of the housing (101); the upper cover (105) is in a shape of a square plate, an inner wall of the upper cover (105) is provided with a cylindrical protrusion; the upper cover (105) is rotatably connected to an outside of the housing (101) through the cylindrical protrusion.

4. The multifunctional battery charger according to claim 1, wherein the magnetic suction holes (202) are circular through holes, and the magnetic suction holes (202) are provided in the rectangular groove of the plug-in punch plate (201) at equidistant.

5. The multifunctional battery charger according to claim 1, wherein the indicator light (203) is inserted into the circular socket of the plug-in punch plate (201); an outer wall or a bottom surface of the new battery (204) is provided with a socket.

6. The multifunctional battery charger according to claim 1, wherein the charging board (301) is in a shape of a square plate, a charging unit is provided on the charging board (301), the control circuit is provided on the charging board (301); the charging interface (3011) is fixed on the charging board (301), and the charging interface (3011) is connected to the control circuit on the charging board (301).

7. The multifunctional battery charger according to claim 1, wherein a bottom of the magnetic charging adapter (303) is provided with a magnetic suction head, the magnetic charging adapter (303) is magnetically connected to the top of the magnetic charging block (302); the indicator board (304) is in a shape of a square plate, a display light is provided in the indicator board (304); the indicator board (304) is electrically connected to the charging board (301).

8. The multifunctional battery charger according to claim 1, wherein the positive electrode plates (305) are fixed at a bottom of the charging board (301) at equidistance, the positive electrode plates (305) are connected to the control circuit on the charging board (301); the negative electrode plates (306) are fixed at the bottom of the charging board (301) at equidistant, and the negative electrode plates (306) are connected to the control circuit on the charging board (301).

9. The multifunctional battery charger according to claim 1, wherein the traditional battery (307) is inserted between the positive electrode plates (305) and the negative electrode plates (306).
